(19) United States
(12) Patent Application Publication
(10) Pub. No.: US 2002/0147946 A1
(43) Pub. Date: Oct. 10, 2002

(54) Method and system for automatic test report generation from memory device reliabilty testing

(76) Inventors: Yong Jaimsomporn, Pakkret Nonthaburi (TH); Somnuek Thongprasert, Bangkok (TH); Sangthip Foongtrakoolratana, Klonglanpattana Klonglan Khamphangphet (TH)

Correspondence Address: Joseph A. Sawyer Jr., SAWYER LAW GROUP LLP, P.O. Box 51418, Palo Alto, CA, 94303, US

(21) Appl. No.: 09/826,628

(22) Filed: Apr. 5, 2001

(51) Int. Cl. G06F 11/00

(52) U.S. Cl. 714/57

(57) ABSTRACT

Aspects for generating test reports from memory device reliability testing are described. The aspects include utilizing a memory device reliability testing system for write endurance testing of a plurality of lots of memory devices. Program instructions are performed to automatically generate a test report from results data of each of a chosen number of the plurality of lots substantially simultaneously.

### FIELD OF THE INVENTION

The present invention relates to reliability testing of Flash EEPROM integrated circuits, and more particularly to automatic test report generation from results of reliability testing.

### BACKGROUND OF THE INVENTION

MiNT7030 Memory Cycling Controller systems, both hardware and software produced by MiNT Company, are used for testing Flash EEPROM integrated circuits. The purpose of the test is to verify that the devices can be erased and to ensure the reliability of the memory cells, i.e., 1,000,000 cycles of writing and erasing. The erasing/reading/writing data are stored in a unique format on a hard drive of the MiNT, with data for 1,000 cycles of erasing/reading/writing stored per file, i.e., data from 100,000 cycles is stored in 100 files. In practice, a report of a lot includes data from 14 cycles, i.e., cycle numbers 1, 100, 1,000, 5,000, 10,000, 20,000, 30,000, 40,000, 50,000, 60,000, 70,000, 80,000, 90,000, and 100,000.

To create a report using the original software from the MiNT requires a user to process the required data from the 14 cycles of a lot one by one. Thus, as represented in the block flow diagram of FIG. 1, the process of test report generation in accordance with the prior art is an iterative process. As shown, the process begins with the selection of one of the generated test results file, e.g., cycle number 1, (step 100). The required data from the results file is then extracted, e.g., speed of a particular device during that cycle (step 110). The data extracted is then exported to a spreadsheet program, e.g., Microsoft Excel, (step 120). These steps are then repeated for each results file from which data is desired (as determined via step 130). Extracting the data of the 14 files while the MiNT is testing other units disturbs the system and normally takes over 15 minutes for the 14 cycles.

Although the original software can automatically export the raw data from the MiNT files to a worksheet, the worksheets still have to be manually reformatted into the actual report (step 140), a task which takes about another 30 minutes per lot and is prone to human error. Total time for creating a test report for 1 lot thus takes over about 45 minutes. It is therefore desirable to develop a new methodology to create test reports from memory device reliability testing that is faster, error-free, and doesn't disturb the test process. The present invention addresses such a need.

### SUMMARY OF THE INVENTION

Aspects for generating test reports from memory device reliability testing are described. The aspects include utilizing a memory device reliability testing system for write endurance testing of a plurality of lots of memory devices. Program instructions are performed to automatically generate a test report from results data of each of a chosen number of the plurality of lots substantially simultaneously.

With the present invention, an automated approach to test result generation is provided that is straightforward for improved efficiency while reducing error. These and other advantages of the aspects of the present invention are described in more detail in the following detailed description in conjunction with the accompanying drawings.

### BRIEF DESCRIPTION OF THE DRAWINGS

FIG. 1 illustrates a test report generation process in accordance with the prior art.

FIG. 2 illustrates a block diagram of a system for test report generation in accordance with the present invention.

FIG. 3 illustrates a block flow diagram for test report generation in accordance with the present invention.

FIG. 4 illustrates a screen shot of a window suitable in the performance of test report generation in accordance with the present invention.

FIG. 5 illustrates a screen shot of a test report automatically generated in accordance with the present invention.

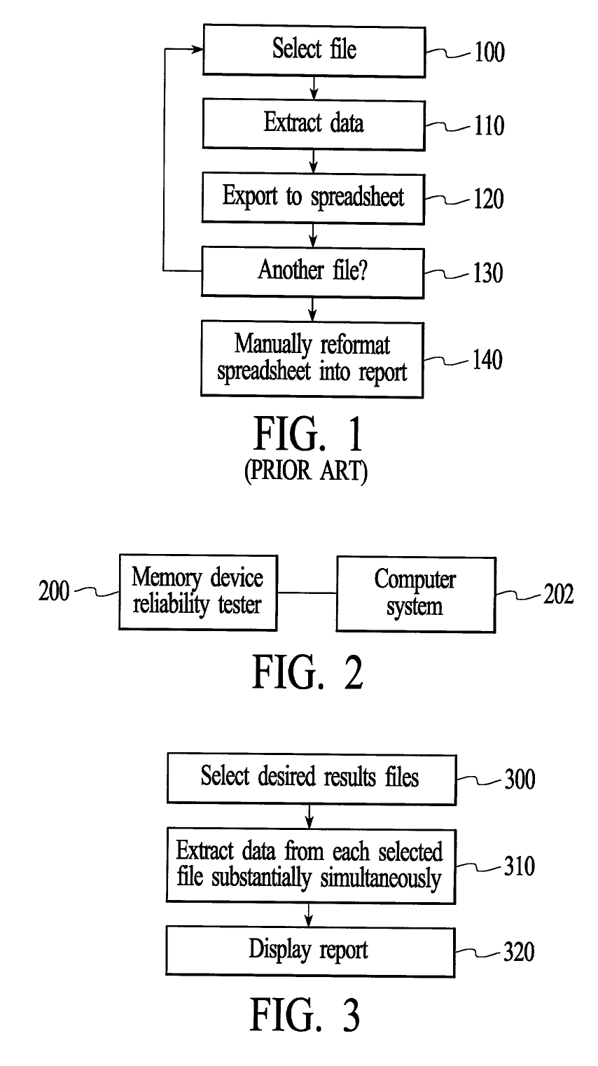

### DESCRIPTION OF THE INVENTION

The present invention relates to reliability testing of Flash EEPROM integrated circuits, and more particularly to automatic test report generation from results of reliability testing. The following is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

FIG. 2 illustrates a system block diagram for generating test reports in accordance with the present invention. As shown, the system includes a memory device reliability tester 200 and a computer processing system 202. By way of example, a MiNT7030 Memory Cycling Controller represents a suitable memory device reliability tester, while a PC (personal computer) with a 486DX/66 or higher processor with Windows95 or higher OS (operating system) represents a suitable computer processing system for the purposes of the present invention.

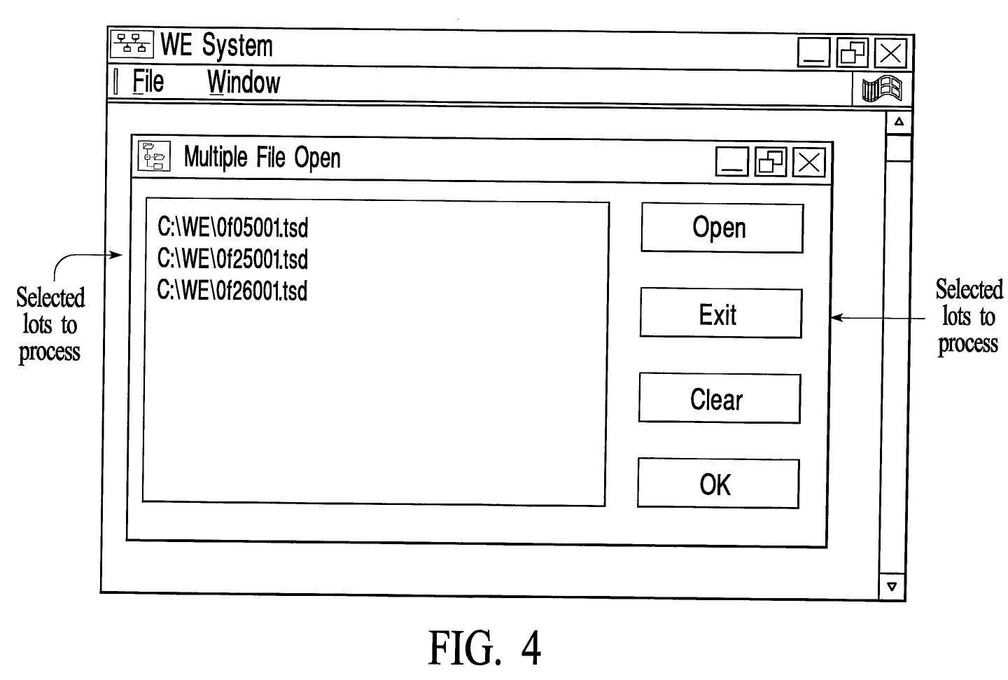

FIG. 3 illustrates an overall block diagram of a process for generating test reports with the system of FIG. 2 in accordance with the present invention. Preferably, the process is performed as program instructions of a Visual Basic program in the computer system 202. The process includes the selection of the results files from one or more desired lots (step 300). FIG. 4 illustrates a screen shot of a displayed window that is suitable for selecting the desired results files.

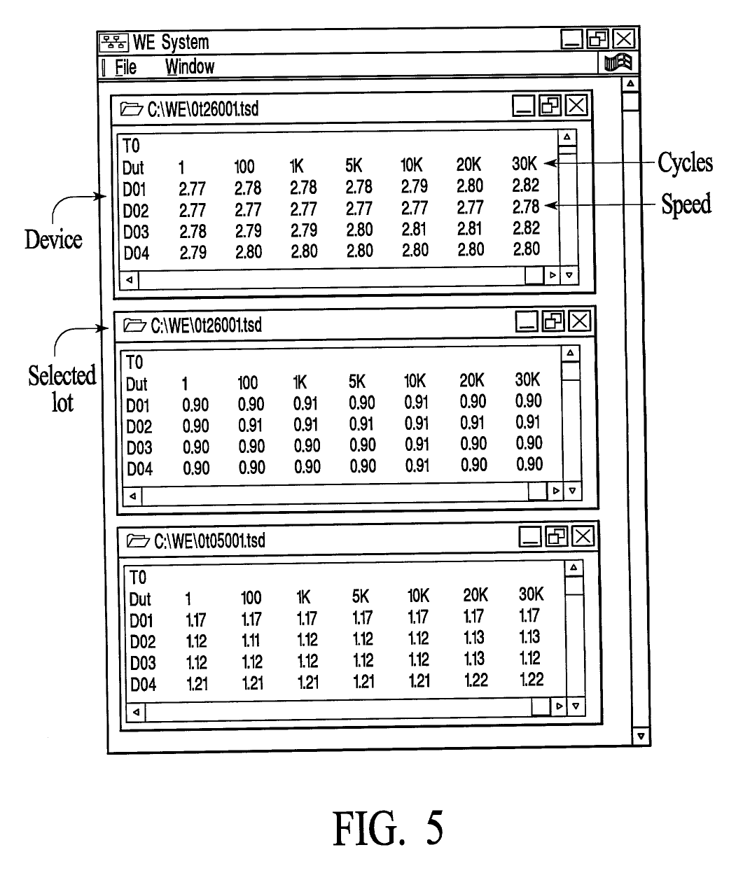

The data of the required test cycles is extracted from the selected results files substantially simultaneously (step 310). With the extracted data, the process then automatically formats the report of each lot in the desired format (step 320). FIG. 5 illustrates a screen shot of the reports generated for the selected files. The automatic nature and straightforward approach of the test report generation in accordance with the present invention provides improved efficiency while reducing error. By way of example, when utilized with a MiNT7030 system, the test report generation of the present invention reduces the time required for reporting test data from the MiNT to around 1.26 per report, with high data integrity.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for generating test reports from memory device reliability testing, the method comprising:
utilizing a memory device reliability testing system for write endurance testing of a plurality of lots of memory devices; and
performing program instructions to automatically generate a test report from results data of each of a chosen number of the plurality of lots substantially simultaneously.

2. The method of claim 1 wherein the step of performing further comprises selecting multiple results files from a plurality of results files generated during the write endurance testing.

3. The method of claim 2 wherein the step of performing further comprises extracting desired data from each of the selected results files.

4. The method of claim 3 wherein the step of performing further comprises automatically formatting the extracted desired data into a desired report format.

5. The method of claim 1 wherein the plurality of memory devices further comprises a plurality of Flash EEPROM integrated circuits.

6. The method of claim 1 wherein the step of performing further comprises performing a Visual Basic program.

7. The method of claim 1 wherein the step of utilizing further comprises utilizing a memory cycling controller system.

8. A system for generating test reports from memory device reliability testing, the system comprising:
a memory device reliability tester for performing write endurance testing on a plurality of lots of memory devices; and
a computer processing system for performing program instructions to automatically generate a test report from results data of each of a chosen number of the plurality of lots substantially simultaneously.

9. The system of claim 8 wherein the memory device reliability tester further comprises a memory cycling controller system.

10. The system of claim 8 wherein the computer processing system performs a Visual Basic program.

11. The system of claim 8 wherein the computer processing system further performs selection of multiple results files from a plurality of results files generated during the write endurance testing.

12. The system of claim 11 wherein the computer processing system further performs extraction of desired data from each of the selected results files.

13. The system of claim 12 wherein the computer processing system further performs automatic formatting of the extracted desired data into a desired report format.

14. The system of claim 8 wherein the plurality of memory devices further comprises a plurality of Flash EEPROM integrated circuits.

15. A method for generating test reports from memory device reliability testing, the method comprising:
selecting multiple results files from a plurality of results files generated during reliability testing of a plurality of lots of semiconductor memory devices;
extracting desired data from each of the selected results files substantially simultaneously; and
automatically formatting the extracted desired data into a desired reports format.

16. The method of claim 15 wherein extracting desired data further comprises extracting desired test cycle data from each of the selected results files.

17. The method of claim 16 wherein selecting further comprises selecting multiple results files from results generated during reliability testing by a memory cycling controller system.

18. The method of claim 15 further comprising performing the steps of selecting, extracting, and automatically formatting as a Visual Basic program.
